(19) United States
(12) Patent Application Publication
(10) Pub. No.: US 2022/0207590 A1
(43) Pub. Date: Jun. 30, 2022

(54) MANAGEMENT SYSTEM, MANAGEMENT METHOD, AND COMPUTER READABLE MEDIUM

(71) Applicant: TOYOTA JIDOSHA KABUSHIKI KAISHA, Toyota-shi Aichi-ken (JP)

(72) Inventors: Yutaro Takagi, Edogawa-ku Tokyo (JP); Kunihiro Iwamoto, Nagakute-shi Aichi-ken (JP); Yuta Itozawa, Nagoya-shi Aichi-ken (JP); Hirotaka Komura, Setagaya-ku Tokyo (JP); Yoshiaki Nakamoto, Nisshin-shi Aichi-ken (JP); Junya Ota, Edogawa-ku Tokyo (JP)

(73) Assignee: TOYOTA JIDOSHA KABUSHIKI KAISHA, Toyota-shi Aichi-ken (JP)

(21) Appl. No.: 17/522,286

(22) Filed: Nov. 9, 2021

(30) Foreign Application Priority Data
Dec. 25, 2020 (JP) 2020-217829

(51) Int. Cl. G06Q 30/06; G06Q 10/08

(52) U.S. Cl. CPC G06Q 30/0633; G06Q 10/087

(57) ABSTRACT

A management system manages automatic ordering of a consumable product. The management system includes: a first acquisition unit that acquires information about an allowable timing of arrival of a target consumable product; a second acquisition unit that acquires information about a delivery timing or an order timing of another article other than the target consumable product; and a determination unit that determines a delivery timing or an order timing of the target consumable product such that the allowable timing is satisfied and the number of times of delivery of the target consumable product and the other article is reduced.

### CROSS-REFERENCE TO RELATED APPLICATION

This application claims priority to Japanese Patent Application No. 2020-217829 filed on Dec. 25, 2020, incorporated herein by reference in its entirety.

### BACKGROUND

### 1. Technical Field

The present disclosure relates to a management system, a management method, and a computer readable medium.

### 2. Description of Related Art

A system for automatically ordering consumable products based on information such as the remaining amount of the consumable products, has been proposed. An order control system for collectively ordering a plurality of consumable products whose ordering timings are close to each other has been disclosed in Japanese Unexamined Patent Application Publication No. 2007-279944 (JP 2007-279944 A).

### SUMMARY

According to the technique described in JP 2007-279944 A, depending on the consumable product, there is a possibility that the order is made too early. In such a technique, improvement in delivery efficiency is desired from users' perspective.

The present disclosure has been made to solve such an issue, and provides a management system, a management method, and non-transitory computer readable medium for improving a delivery efficiency in an allowable timing of arrival of a consumable product.

A management system according to a first aspect of the present disclosure is a management system for managing automatic ordering of a consumable product, and includes: a first acquisition unit that acquires information about an allowable timing of arrival of a target consumable product; a second acquisition unit that acquires information about a delivery timing or an order timing of another article other than the target consumable product; and a determination unit that determines a delivery timing or an order timing of the target consumable product such that the allowable timing is satisfied and the number of times of delivery of the target consumable product and the other article is reduced.

A management method according to a second aspect of the present disclosure is a management method for managing automatic ordering of a consumable product, and includes: a step of acquiring, with a computer, information about an allowable timing of arrival of a target consumable product; a step of acquiring, with the computer, information about a delivery timing or an order timing of another article other than the target consumable product; and a step of determining, with the computer, a delivery timing or an order timing of the target consumable product such that the allowable timing is satisfied and the number of times of delivery of the target consumable product and the other article is reduced.

A computer readable medium according to a third aspect of the present disclosure stores a management program for managing automatic ordering of a consumable product. The management program causes a computer to execute: a process of acquiring information about an allowable timing of arrival of a target consumable product; a process of acquiring information about a delivery timing or an order timing of another article other than the target consumable product; and a process of determining a delivery timing or an order timing of the target consumable product such that the allowable timing is satisfied and the number of times of delivery of the target consumable product and the other article is reduced.

The present disclosure can provide a management system, a management method, and a computer readable medium for improving a delivery efficiency in an allowable timing of arrival of a consumable product.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a system configuration of a management system according to a first embodiment;

FIG. 2 is a block diagram showing a configuration of a management server according to the first embodiment;

FIG. 3 is a flowchart showing a flow of a management method according to the first embodiment;

FIG. 4 is a block diagram showing a configuration of a management server according to a second embodiment;

FIG. 5 is a flowchart showing a flow of a management method according to the second embodiment;

FIG. 6 is a block diagram showing a configuration of a management server according to a third embodiment; and

FIG. 7 is a flowchart showing a flow of a management method according to the third embodiment.

### DETAILED DESCRIPTION OF EMBODIMENTS

Hereinafter, the present disclosure will be described through embodiments of the present disclosure, but the disclosure according to the claims is not limited to the following embodiments. Moreover, not all of the configurations described in the embodiments are indispensable for solving the issues.

### First Embodiment

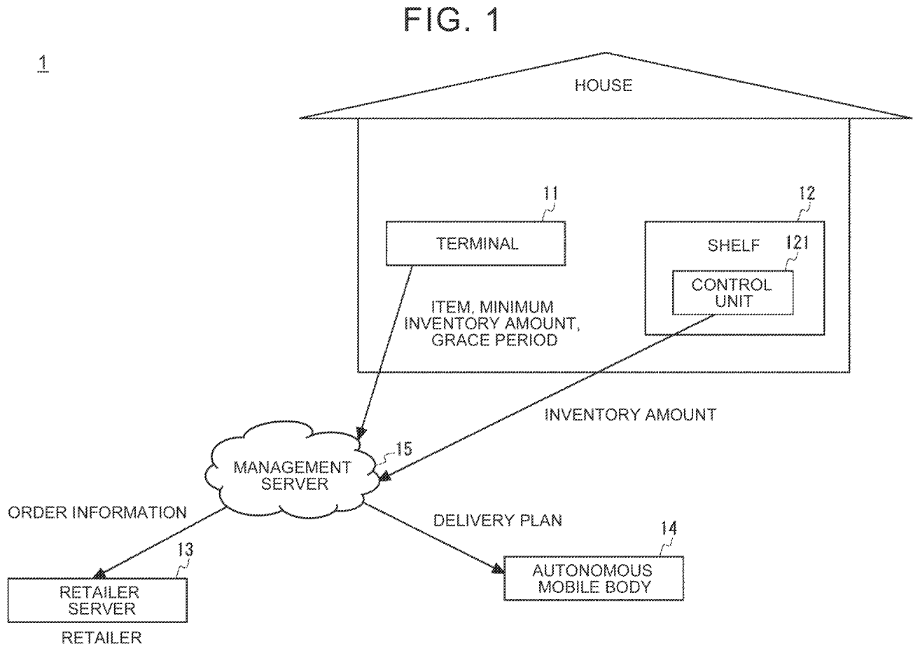

A management system according to a first embodiment will be described with reference to the drawings. FIG. 1 is a block diagram showing a configuration of a management system 1 according to a first embodiment. The management system 1 is a management system that manages inventory of consumable products. The consumable products represent articles that can be consumed, and for example, include daily products, food, and the like. The management system 1 manages the inventory of the consumable products in a house. The management system 1 performs automatic ordering in accordance with the consumption of the consumable products. The management system 1 also creates a delivery plan for delivering the consumable products received from a retailer such as an electronic commerce (EC) vendor to the house. In the following, description will be made focusing on an example in which consumable products are delivered by an autonomous mobile body. However, the delivery need not to be performed by the autonomous mobile body. For example, the delivery may be performed by a vehicle driven by a human.

The management system 1 includes a terminal 11, a shelf 12, a retailer server 13, an autonomous mobile body 14, and a management server 15. Here, the shelf 12 is provided with a control unit 121 that performs various controls.

The processing performed by the management system 1 may be performed in the shelf 12 or the autonomous mobile body 14. Thus, the management system 1 may include a system that does not include the management server 15 and in which the processing is completed in the shelf 12.

The terminal 11, the control unit 121, the retailer server 13, the autonomous mobile body 14, and the management server 15 each include a calculation unit such as a central processing unit (CPU) and a storage unit such as a random access memory (RAM) and a read-only memory (ROM) that stores various control programs, data, and the like. That is, the terminal 11, the control unit 121, the retailer server 13, the autonomous mobile body 14, and the management server 15 each have functions as a computer, and perform the following processing based on the various control programs and the like.

The terminal 11 is a communication terminal wired or wirelessly connected to the management server 15 so as to be able to communicate with the management server 15. The terminal 11 is not particularly limited, as long as it can communicate with the management server 15. The terminal 11 is, for example, a mobile communication terminal such as a smartphone and a tablet, a personal computer (PC) and the like installed in the house.

As shown in FIG. 1, the terminal 11 is located in the living space of the house. However, the terminal 11 may be located outdoors or outside the living space in the house. Further, in the present specification, the house includes an apartment house, an office building, and the like, and the living space includes an office space.

The user inputs, to the terminal 11, items of the consumable products, the minimum inventory amount, the length of a period for which the inventory amount is allowed to be equal to or less than the minimum inventory amount (hereinafter, referred to as grace period). The information is transmitted from the terminal 11 to the management server 15.

The shelf 12 accommodates articles including a consumable product used in the house. The shelf 12 may accommodate a plurality of kinds of consumable products. The shelf 12 may be installed outside the house. The quantity of the consumable products accommodated is managed by the management server 15 to be described later. A device for measuring the quantity of the consumable products taken out from the shelf 12 or a sensor for measuring the quantity of the consumable products accommodated may be attached to the shelf 12. The sensor may be a weight sensor or a camera. The control unit 121 of the shelf 12 transmits the inventory amount and the consumption amount of the consumable products to the management server 15.

The retailer server 13 is a server operated by a retailer. The retailer server 13 is, for example, a server constituting an EC site that is operated by an EC vendor on the Internet. The retailer server 13 and the management server 15 are connected so as to be able to communicate with each other. The retailer server 13 receives order information. The autonomous mobile body 14 receives consumable products from the retailer and delivers the consumable products to the shelf 12. When the consumable products have already been delivered to a predetermined distribution base, the autonomous mobile body 14 may receive the consumable products at the distribution base and store the consumable products on the shelf 12. The autonomous mobile body 14 is, for example, an autonomous driving vehicle and a delivery robot. Note that, as described above, the delivery may be performed by a human.

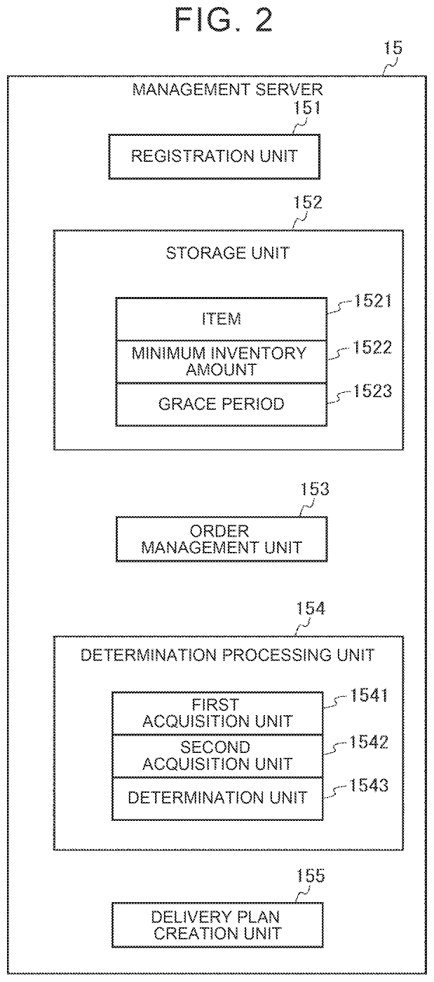

The management server 15 manages the consumable products accommodated in the shelf 12. FIG. 2 is a block diagram showing a functional configuration of the management server 15. The management server 15 includes a registration unit 151, a storage unit 152, an order management unit 153, a determination processing unit 154, and a delivery plan creation unit 155. When the delivery is not performed by the autonomous mobile body 14, the management server 15 need not to include the delivery plan creation unit 155. Further, the delivery plan creation unit 155 may create a delivery plan for human delivery. In such a case, the delivery plan may be transmitted to a vehicle driven by a human or a terminal carried by a human.

The registration unit 151 associates an item 1521, a minimum inventory amount 1522, and a length of the period for which the inventory amount is allowed to be equal to or less than the minimum inventory amount (hereinafter, referred to as grace period 1523) with each other based on input by the user to the terminal 11 so as to register them to the storage unit 152. The item is also referred to as a consumable product item identification (ID). The grace period 1523 may be, for example, a period until the consumable product of the minimum inventory amount is used up. The storage unit 152 manages the minimum inventory amount 1522 of the consumable product and the grace period 1523 in association with the item 1521. The storage unit 152 is also referred to as a storage device. This allows the user to manage and register the item 1521, the minimum inventory amount 1522, and the grace period 1523.

The management server 15 may generate a combination of the item 1521, the minimum inventory amount 1522, and the grace period 1523 based on the use history or the like by the user and transmit the combination to the terminal 11. In such a case, the registration unit 151 may register the combination to the storage unit 152 in response to approval by the user.

The order management unit 153 manages the inventory amount of the consumable product accommodated in the shelf 12. The order management unit 153 may manage the inventory amount of the consumable product using measurement results of a weight meter. The order management unit 153 may manage the inventory amount using images captured by the camera. The order management unit 153 determines whether the inventory amount of the consumable product is less than the minimum inventory amount 1522 registered in the storage unit 152. When the determination result is YES, the order management unit 153 orders the consumable product. The order quantity may be a predetermined quantity.

The order management unit 153 may manage the previous ordering date of each consumable product and the delivery timing of each consumable product. The delivery timing is also referred to as delivery date and time. The delivery timing that is managed may be a timing determined in the past by the determination processing unit 154 to be described later.

The determination processing unit 154 determines the delivery timing of the ordered consumable product. The determination processing unit 154 is provided with a first acquisition unit 1541, a second acquisition unit 1542, and a determination unit 1543. The determination processing unit 154 may determine the delivery timing when the delivery is performed after arrangement of the consumable product is completed. For example, the determination processing unit 154 may determine the delivery timing when receiving a notification indicating that the arrangement has been completed from the retailer server 13 or the distribution center.

The first acquisition unit 1541 acquires information about an allowable period for which arrival of the consumable product to be shipped is allowed. The allowable period is, for example, a period from the date and time of order (or when the inventory amount becomes less than the minimum inventory amount) until the grace period 1523 expires. In such a case, the first acquisition unit 1541 acquires the grace period 1523 of the ordered consumable product as the information about the allowable period. Although described as a modification at the end of the description of the first embodiment, the information about the allowable period may be acquired based on the user's input, the user's schedule, or the like.

The second acquisition unit 1542 acquires information about the delivery timing of another article other than the consumable product to be shipped. The other article may be another consumable product managed by the management server 15. The other article may be an article other than the consumable product. The second acquisition unit 1542 may acquire information about the delivery timing of each of the plurality of articles. The second acquisition unit 1542 may acquire information about the delivery timing of the other article from the retailer server 13. The second acquisition unit 1542 may acquire the delivery timing of each consumable product managed by the order management unit 153.

The second acquisition unit 1542 may acquire the delivery timing of the other article by predicting the delivery timing from the order timing. It is considered possible to predict the delivery timing from the order timing, when the delivery date and the like of the article is specified, for example. The second acquisition unit 1542 may predict the order timing and the delivery timing of the other article based on the change in the consumption amount of the other article accommodated in the shelf 12, and may acquire the delivery timing of the other article based on the prediction result.

The determination unit 1543 determines the delivery timing of the consumable product to be shipped such that the allowable period is satisfied and the number of times of delivery of the consumable product and the other article is reduced. The determination unit 1543 determines, for example, the delivery timing of the target consumable product at the same time as the delivery timing of the other article. Since the target consumable product and the other article are delivered together, the number of times of delivery can be reduced. As described above, the determined delivery timing may be managed for each consumable product by the order management unit 153.

The delivery plan creation unit 155 creates a delivery plan for receiving the consumable product from the retailer and delivering the consumable product to the shelf 12 at the determined delivery timing, and transmits the delivery plan to the autonomous mobile body 14. As described above, the creation of the delivery plan may be performed in the autonomous mobile body 14. Further, as described above, the delivery plan creation unit 155 may create a delivery plan for human delivery.

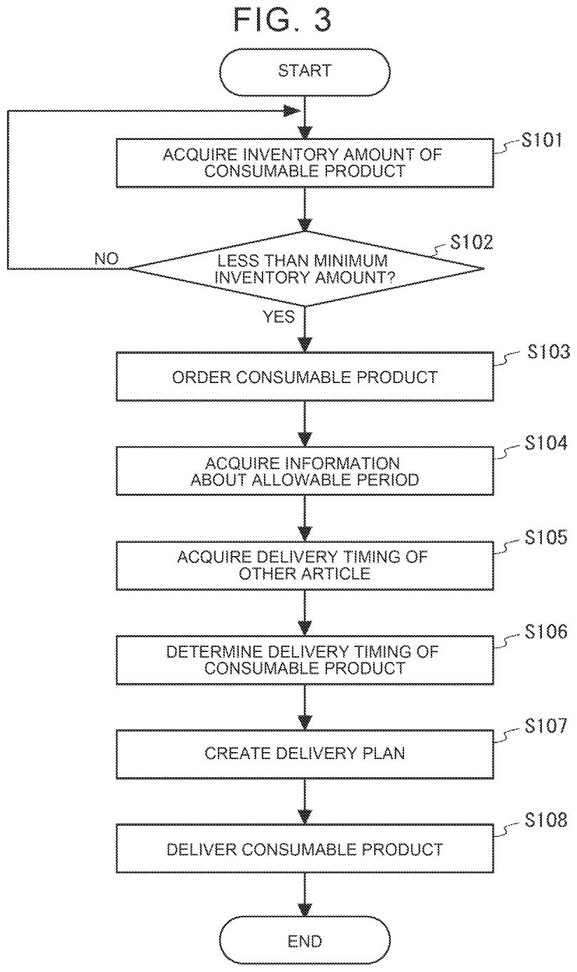

FIG. 3 is a flowchart illustrating a flow of the management method according to the first embodiment. The item, the minimum inventory number, and the grace period of the consumable product are registered based on the input by the user.

First, the order management unit 153 acquires the inventory amount of the consumable product accommodated in the shelf 12 (step S101). Acquisition of the inventory amount of the consumable product may be performed periodically. The acquisition of the inventory amount of the consumable product may be performed when the article is taken out from the shelf. Next, the order management unit 153 determines whether the acquired inventory amount of the consumable product is less than the minimum inventory amount (step S102). When the acquired inventory amount of the consumable product is not less than the minimum inventory amount (No in step S102), the process returns to the step S101.

Next, when the acquired inventory amount of the consumable product is less than the minimum inventory amount (Yes in step S102), the order management unit 153 orders the consumable product (step S103). For example, when the arrangement of the ordered consumable product is completed, the first acquisition unit 1541 acquires the grace period 1523 of the target consumable product as the information about the allowable period (step S104), and specifies the allowable period for which arrival is allowed. The allowable period is, for example, a period from the current time until the grace period 1523 expires.

Next, the second acquisition unit 1542 acquires the information about the delivery timing of the other article other than the target consumable product (step S105). Next, the determination unit 1543 determines the delivery timing based on the information acquired in the step S105 such that the allowable period specified in the step S103 is satisfied and the number of times of delivery of the target consumable product and the other article to the shelf is reduced (step S106).

Next, the delivery plan creation unit 155 creates a delivery plan such that the consumable product is delivered at the determined delivery timing (step S107). The autonomous mobile body 14 delivers the consumable product in accordance with the created delivery plan (step S108). The delivery of the consumable product may be performed by a human in accordance with the delivery plan.

The delivery system according to the first embodiment performs automatic ordering in accordance with the minimum inventory amount of the consumable product and creates a delivery plan such that the number of times of delivery is reduced in accordance with the grace period. Thus, it becomes possible to deliver the consumable product efficiently. In addition, when the autonomous mobile body transports the consumable product, it is possible to reduce the number of times that the autonomous mobile body moves inside or outside the house.

In addition, when the item, the minimum inventory amount, and the grace period are set by the user, automatic ordering and arrangement are performed in accordance with the setting. In this case, the instruction by the user is not required, so it is possible to improve the convenience for the user.

Further, according to the first embodiment, the user need not to manage the inventory or purchase the consumable product by himself/herself, so it is possible to reduce the user's labor (time). When the minimum inventory amount is set, it is possible to keep the inventory amount of the consumable product appropriately.

First Modification

In the description above, the case where the grace period is set in advance for each consumable product is described. However, the grace period may be determined at the time of ordering, based on the input by the user to the terminal 11. Furthermore, the input may be the length of the period (grace period), or input of specifying the date and time serving as the deadline (allowable timing of arrival).

Also, the allowable timing of arrival need not to be specified based on a period for which the inventory amount is allowed to be less than the minimum inventory amount. The allowable timing may be a period for which the user can receive the ordered consumable product. When the user is away on a trip or a long business trip, for example, the management system 1 may acquire the absence period from the scheduler and set the period for which the user can receive as the allowable timing.

Even in such a case, the management system 1 can improve the delivery efficiency while satisfying the allowable period of delivery.

### Second Embodiment

The management system according to the first embodiment determines the delivery timing after ordering of the consumable product. On the other hand, the management system according to the second embodiment determines the delivery timing at the time of ordering the consumable product. The management system according to the second embodiment has the same system configuration as that in FIG. 1.

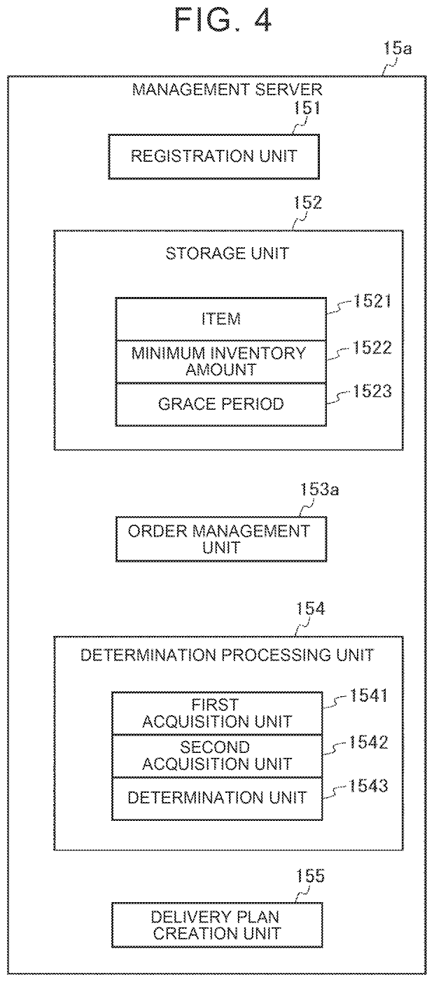

FIG. 4 is a block diagram showing a functional configuration of a management server 15a according to the second embodiment. In the management server 15a, the order management unit 153 is replaced by an order management unit 153a, as compared with the management server 15 described above.

Similar to the order management unit 153, the order management unit 153a orders the consumable product when the inventory amount of the consumable product becomes less than the minimum inventory amount 1522. When ordering the consumable product, the order management unit 153a causes the determination processing unit 154 to determine the delivery date and time. The determination processing unit 154 determines the delivery timing in the same manner as in the first embodiment. The order management unit 153a transmits the information about the determined delivery timing to the retailer server 13.

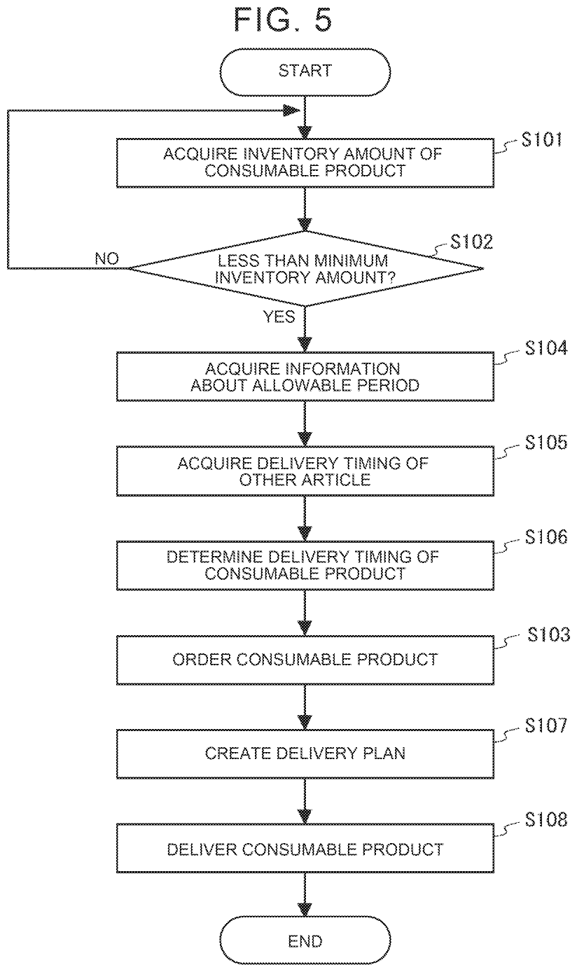

FIG. 5 is a flowchart showing a flow of the management method according to the second embodiment. Comparing FIGS. 3 and 5, step S103 is replaced by steps S104 to S106. Steps S101 to S102 are the same as those in the first embodiment, so description thereof is omitted.

When the inventory amount of the consumable product is less than the minimum inventory amount (Yes in step S102), the determination processing unit 154 acquires the information about the allowable period (step S104), acquires the information about the delivery timing of the other article (step S105), and determines the delivery timing such that the number of times of delivery is reduced (step S106). Next, the order management unit 153a orders the consumable product by specifying the determined delivery timing (step S103). The processes in steps S107 to S108 are the same as those in FIG. 3, so description thereof is omitted.

Also in the second embodiment, it is possible to achieve the same effects as those in the first embodiment. Retailers can make efficient arrangements by making bulk purchases by the delivery timing.

### Third Embodiment

The management system according to the second embodiment determines the delivery timing of the consumable product. The management system according to the third embodiment determines the order timing of the consumable product. That is, the management system according to the third embodiment does not place an order at the timing when the inventory amount of the consumable product becomes less than the minimum inventory amount, but places an order at the determined order timing. The management system according to the third embodiment has the same system configuration as that in FIG. 1.

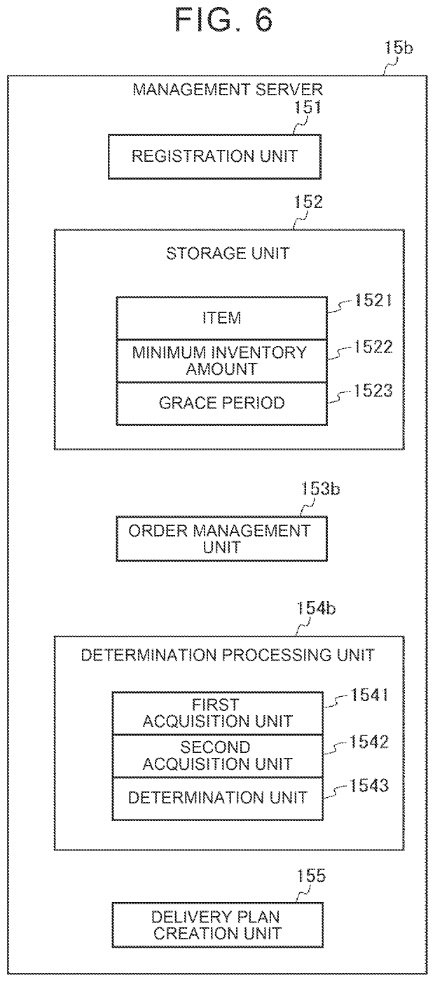

FIG. 6 is a block diagram showing a functional configuration of a management server 15b according to the third embodiment. In the management server 15b, the order management unit 153a is replaced by an order management unit 153b and the determination processing unit 154 is replaced by a determination processing unit 154b, as compared with the management server 15a described above.

When the inventory amount of the consumable product is less than the minimum inventory amount 1522, the order management unit 153b orders the consumable product, as in the second embodiment. Here, the order management unit 153b causes the determination processing unit 154b to determine the order timing and places an order at the determined timing. The determination processing unit 154b determines the order timing, for example, such that the delivery timing of the other article that has already been ordered matches the delivery timing of the target consumable product. Here, the order timing may be determined by considering the delivery date of the consumable product.

The determination processing unit 154b includes a first acquisition unit 1541, a second acquisition unit 1542, and a determination unit 1543. The first acquisition unit 1541 acquires information about the allowable period until the arrival of the consumable product to be ordered. Further, the second acquisition unit 1542 acquires the delivery timing and the like of the other article other than the consumable product to be ordered. The delivery timing may be acquired based on the order timing of the other article. Here, the order timing may be predicted based on the consumption amount of the consumable product. Thus, the other article need not to be already ordered.

The determination unit 1543 determines the order timing of the consumable product to be ordered such that the number of times of delivery of the consumable product and the other article to be ordered is reduced while the allowable period is satisfied. The order timing is determined so as to satisfy the allowable period of the delivery timing, considering the delivery date of the consumable product and the like. The determination unit 1543 determines the order timing such that the number of times of delivery of the article is smaller, out of the order period that satisfies the allowable period.

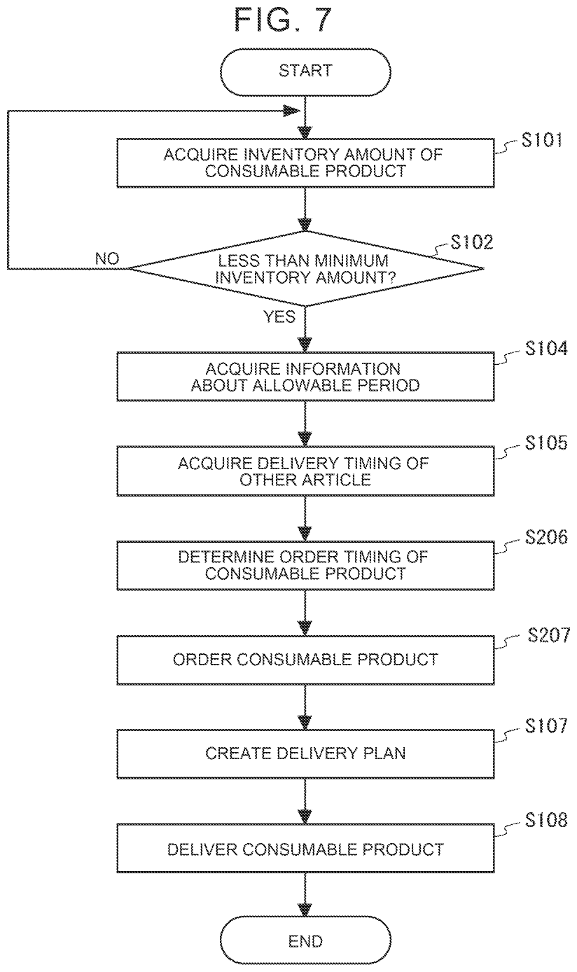

FIG. 7 is a flowchart showing a flow of the management method according to the third embodiment. Steps S101, S102, S104, and S105 are similar to those in FIG. 5, so description thereof is omitted. In step S206, the management server 15b determines the order timing of the consumable product such that the allowable period is satisfied and the number of times of delivery is reduced (step S206). Then, the management server 15b orders the consumable product at the order timing determined in step S206 (step S207). The processes of step S207 and the subsequent steps are the same as those in FIG. 5, so description thereof is omitted.

Also in the third embodiment, it is possible to achieve the same effects as those in the second embodiment.

In the above example, various programs can be stored using various types of non-transitory computer readable media and supplied to a computer. The non-transitory computer readable medium includes various types of tangible storage media. Examples of the non-transitory computer readable medium include a magnetic recording medium (for example, flexible disk, magnetic tape, hard disk drive), a magneto-optical recording medium (for example, magneto-optical disk), a compact disc read-only memory (CD-ROM), a compact disc recordable (CD-R), a compact disc rewritable (CD-R/W), and a semiconductor memory (for example, a mask ROM, a programmable ROM (PROM), an erasable PROM (EPROM), a flash ROM, a random access memory (RAM)). The program may also be supplied to the computer by various types of transitory computer readable media. Examples of the transitory computer readable medium include electric signals, optical signals, and electromagnetic waves. The transitory computer readable medium can supply the program to the computer via a wired communication path such as an electric wire and an optical fiber, or a wireless communication path.

The present disclosure is not limited to the above embodiment, and can be appropriately modified without departing from the scope of the disclosure.

What is claimed is:

1. A management system for managing automatic ordering of a consumable product, the management system comprising:
a first acquisition unit that acquires information about an allowable timing of arrival of a target consumable product;
a second acquisition unit that acquires information about a delivery timing or an order timing of another article other than the target consumable product; and
a determination unit that determines a delivery timing or an order timing of the target consumable product such that the allowable timing is satisfied and the number of times of delivery of the target consumable product and the other article is reduced.

2. The management system according to claim 1, further comprising:
a storage device that manages a minimum inventory number of the consumable product and a length of a period for which an inventory number of the consumable product is allowed to be equal to or less than the minimum inventory number, in association with an item of the consumable product; and
an ordering unit that orders the consumable product when the inventory number of the consumable product is equal to or less than the minimum inventory number,
wherein the first acquisition unit acquires the length of the period for the target consumable product, as information about the allowable timing.

3. The management system according to claim 2, further comprising a registration unit that associates the item, the minimum inventory number, and the length of the period with each other to register the item, the minimum inventory number, and the length of the period to the storage device, based on input by a user.

4. The management system according to claim 2, wherein:
the determination unit determines the delivery timing of the target consumable product; and
the management system further includes a delivery plan creation unit that creates a delivery plan for delivering the target consumable product at the delivery timing.

5. The management system according to claim 2, wherein:
the determination unit determines the order timing of the target consumable product; and
the ordering unit orders the target consumable product at the order timing.

6. A management method for managing automatic ordering of a consumable product, the management method comprising:
a step of acquiring, with a computer, information about an allowable timing of arrival of a target consumable product;
a step of acquiring, with the computer, information about a delivery timing or an order timing of another article other than the target consumable product; and
a step of determining, with the computer, a delivery timing or an order timing of the target consumable product such that the allowable timing is satisfied and the number of times of delivery of the target consumable product and the other article is reduced.

7. A non-transitory computer readable medium that stores a management program for managing automatic ordering of a consumable product, the management program causing a computer to execute:
a process of acquiring information about an allowable timing of arrival of a target consumable product;
a process of acquiring information about a delivery timing or an order timing of another article other than the target consumable product; and
a process of determining a delivery timing or an order timing of the target consumable product such that the allowable timing is satisfied and the number of times of delivery of the target consumable product and the other article is reduced.
